(19) United States
(12) Patent Application Publication
(10) Pub. No.: US 2015/0101868 A1
(43) Pub. Date: Apr. 16, 2015

(54) BALANCING OF DRILL BITS

(71) Applicant: SMITH INTERNATIONAL, INC., Houston, TX (US)

(72) Inventors: Luca Tedeschi, Volterra PI (IT); Gary Portwood, Firenze (IT); Zhehua Zhang, The Woodlands, TX (US)

(21) Appl. No.: 14/514,268

(22) Filed: Oct. 14, 2014

Related U.S. Application Data
(60) Provisional application No. 61/891,544, filed on Oct. 16, 2013.

(51) Int. Cl. E21B 10/08; B23P 15/28; E21B 10/18

(52) U.S. Cl. CPC E21B 10/083; E21B 10/18; B23P 15/28
USPC 175/353; 76/108.1; 76/108.2

(57) ABSTRACT

A method including of manufacturing a drill bit includes inputting bit characteristics into a simulator. The bit characteristics may include a drill bit mass, coordinates of the bit center of gravity, and an inertia tensor of the bit. The bit center of gravity and a vector of the inertia tensor may be aligned with a bit axis in the simulator. Based on the alignment of the center of gravity and the inertia tensor with the bit axis, new bit characteristics may be determined. A drill bit with the new bit characteristics may be produced.

### CROSS REFERENCE TO RELATED APPLICATION

This application claims the benefit to and priority of U.S. Provisional Application 61/891,544 filed on Oct. 16, 2013, the entirety of which is incorporated herein by reference.

### BACKGROUND

Roller cone bits are used in earth drilling applications such as petroleum or mining operations. Roller cone bits include one or more roller cones rotatably mounted to a bit body. These roller cones have a plurality of cutting elements attached thereto that crush, gouge, and scrape rock at the bottom of a hole being drilled. The cutting structure of a roller cone bit includes two or three rotatable roller cones mounted on legs of a bit body. Two cone bits include two legs with journals and roller cones mounted thereon. The two cone bit often suffers from stability issues related to near bit vibrations. Thus, more stable three cone roller bits are often used in commercial applications due to the increased stability.

However, two cone drill bits do pose some advantages over three cone bits. Particularly, two cone drill bits have a higher rate of penetration than three cone bits. Two cone bits may also have larger bearings which results in a longer bearing life. Additionally, two cone drill bits may have better hydraulics than a three cone drill bit due to more room for nozzles allowing for faster cuttings evacuation.

### SUMMARY OF THE DISCLOSURE

In one aspect, embodiments of the present disclosure include a method including inputting drill bit characteristics into a simulator, wherein drill bit characteristics include a drill bit mass, coordinates of the drill bit center of gravity, or an inertia tensor of the drill bit, aligning the drill bit center of gravity and a vector of the inertia tensor with a bit axis in the simulator, where the bit axis runs longitudinally through the center of the drill bit, determining new drill bit characteristics based on the aligning the center of gravity and the inertia tensor with the bit axis, and producing a drill bit with the new bit characteristics.

In another aspect, embodiments of the present disclosure include a method including assembling a drill bit, inputting drill bit characteristics into a simulator, performing a mass balance with a simulator, determining new drill bit characteristics, modifying the drill bit by adding or removing mass according to the new mass distribution.

In another aspect, embodiments of the present disclosure include a drill bit including a body, two legs mounted to the body, two journals, one of the two journals mounted to each of the two legs, the two journals having a cone separation angle of less than 180 degrees, two roller cones, one of the two roller cones mounted to each of the two journals, where the drill bit has a center of gravity substantially aligned with a bit axis.

In yet another aspect, embodiments of the present disclosure include a method including producing a two cone roller cone drill bit having a cone separation angle of less than 180 degrees, where the producing comprises aligning a center of gravity of the two cone roller cone drill bit with a bit axis.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF DRAWINGS

FIG. 1 shows a perspective view of a two cone drill bit in accordance with an embodiment of the present disclosure.

FIG. 2 shows a perspective view of a two cone drill bit in accordance with an embodiment of the present disclosure.

FIG. 3 shows a perspective view of a two cone drill bit with respect to the x axis and y axis.

FIG. 4 shows a perspective view of a two cone drill bit with respect to the x axis and z axis.

FIG. 5 shows a perspective view of a two cone drill bit with respect to the y axis and z axis.

FIG. 6 shows a top view of a model of a drill bit in accordance with an embodiment of the present disclosure.

FIG. 7 shows a perspective view of a model of a drill bit in accordance with an embodiment of the present disclosure.

FIG. 8 shows a perspective view of a leg in accordance with an embodiment of the present disclosure.

FIG. 9 shows a perspective view of a wedge section in accordance with an embodiment of the present disclosure.

FIG. 10 shows an exploded view of a bit body in accordance with an embodiment of the present disclosure.

FIG. 11 shows a perspective view of a drill bit with respect to various axes.

FIG. 12 shows a bottom view of a drill bit.

FIG. 13 shows a bottom view of a drill bit in accordance with an embodiment of the present disclosure.

FIG. 14 shows a bottom view of a drill bit in accordance with an embodiment of the present disclosure.

FIG. 15 shows a bottom view of a drill bit in accordance with an embodiment of the present disclosure.

FIG. 16 shows a bottom view of a drill bit in accordance with an embodiment of the present disclosure.

FIG. 17 shows a bottom view of a drill bit in accordance with an embodiment of the present disclosure.

### DETAILED DESCRIPTION

In the following detailed description of embodiments, numerous specific details are set forth in order to provide a more thorough understanding. However, it will be apparent to one of ordinary skill in the art that the disclosed subject matter of the application may be practiced without these specific details. In other instances, well-known features have not been described in detail to avoid unnecessarily complicating the description.

Generally, embodiments disclosed herein relate to roller cone drill bits and methods manufacturing roller cone drill bits. In one aspect, embodiments disclosed herein relate to methods of increasing the stability of roller cone drill bits through mass-balancing of the drill bit. In another aspect, embodiments disclosed herein relate to methods of increasing the stability of two cone drill bits.

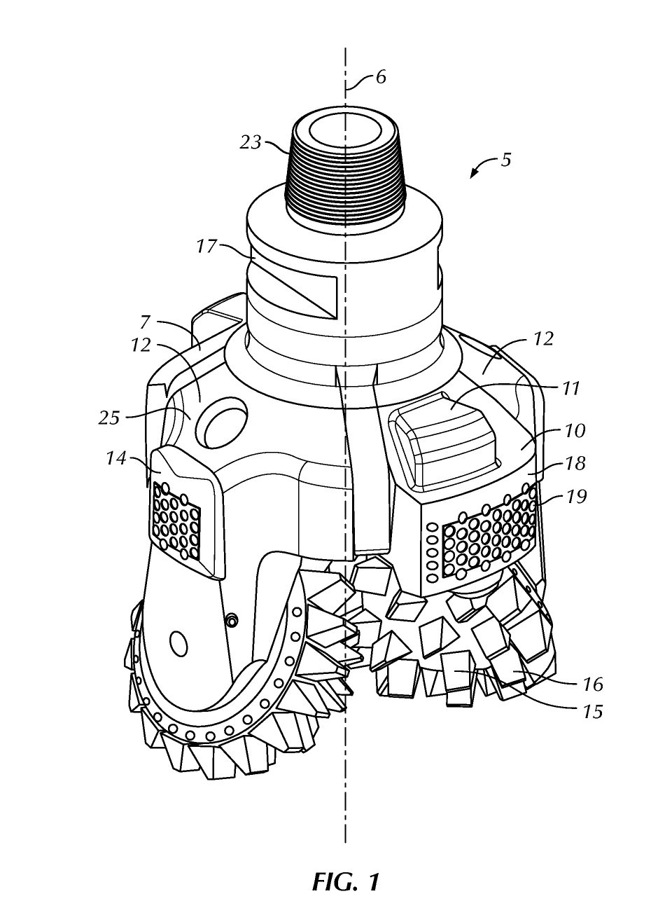

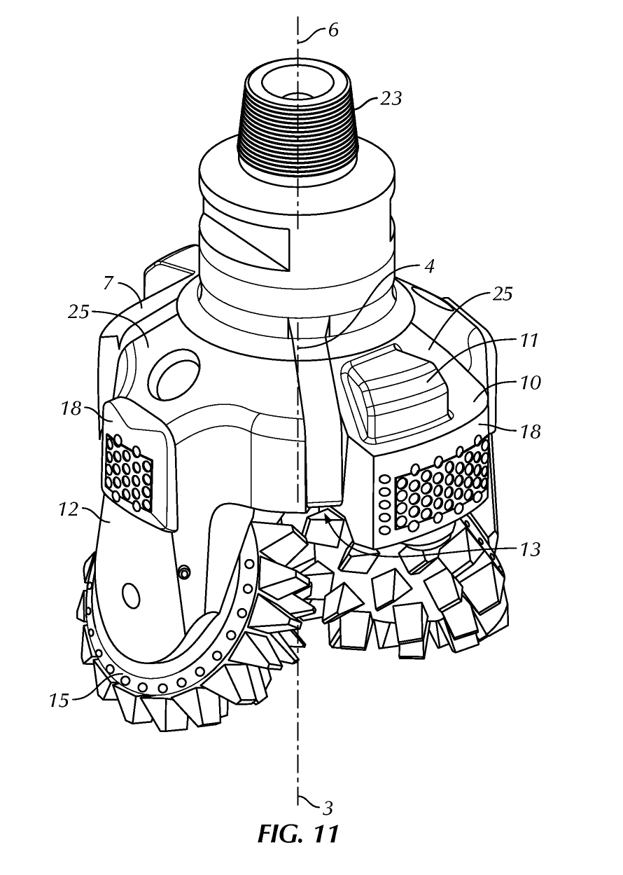

Referring initially to FIGS. 1 and 11, a perspective view of a two cone roller bit according to an embodiment of the present disclosure is provided. A two cone drill bit 5 may include a bit body 7 that includes a wedge section 10 and a leg 12 extending from each side of the wedge section 10 and a pin end 23 mounted to an upper end of the bit body 7.

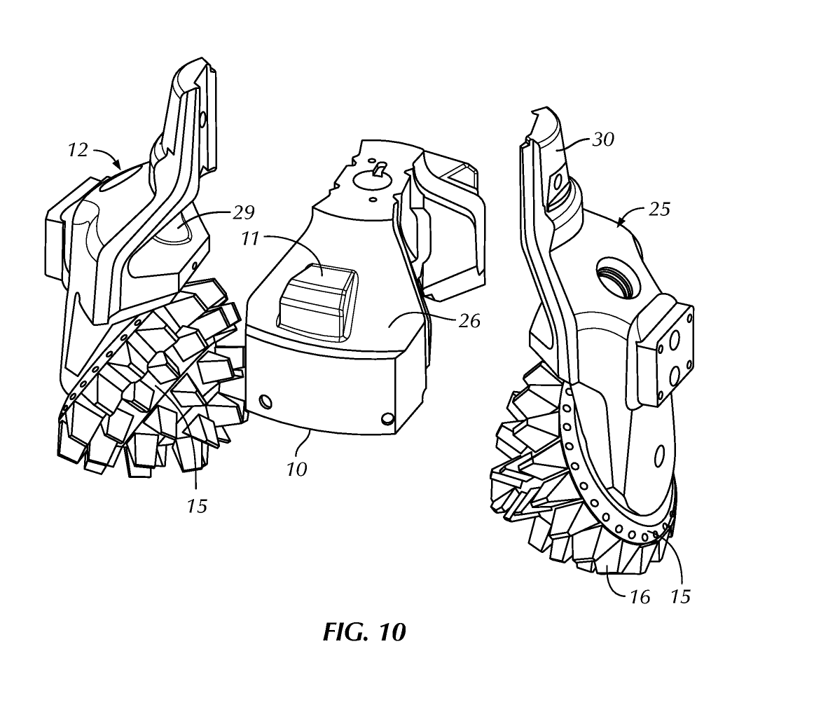

Referring to FIGS. 8 and 10, the legs 12 may be separately formed and mounted on either side of the wedge 10, such as by welding, but the present disclosure is not so limited. Rather, the present disclosure also relates to other methods of manufacturing in which the legs 12 may be integrally formed with the wedge 10 to form the bit body 7. The legs 12 include a tapered shoulder 25 disposed on the upper end of the leg 12, on the transition between the leg backface 28 and upper receiving portion 30 (or pin 23 once the bit is assembled). In some embodiments, legs 12 may be machined to include a journal 14 integrally formed with the leg 12. In other embodiments, the journal may be machined separately and subsequently coupled to the leg 12 by, for example, welding or other coupling means known in the art. Each leg 12 may include a journal 14 mounted thereon, and a roller cone 16 may be mounted to each journal 14. Each of the roller cones 16 generally have a plurality of cutting elements 15 thereon, which may include milled teeth or inserts, as known in the art of roller cone bits. The cutting elements 15 are configured to engage with an earth formation during operation.

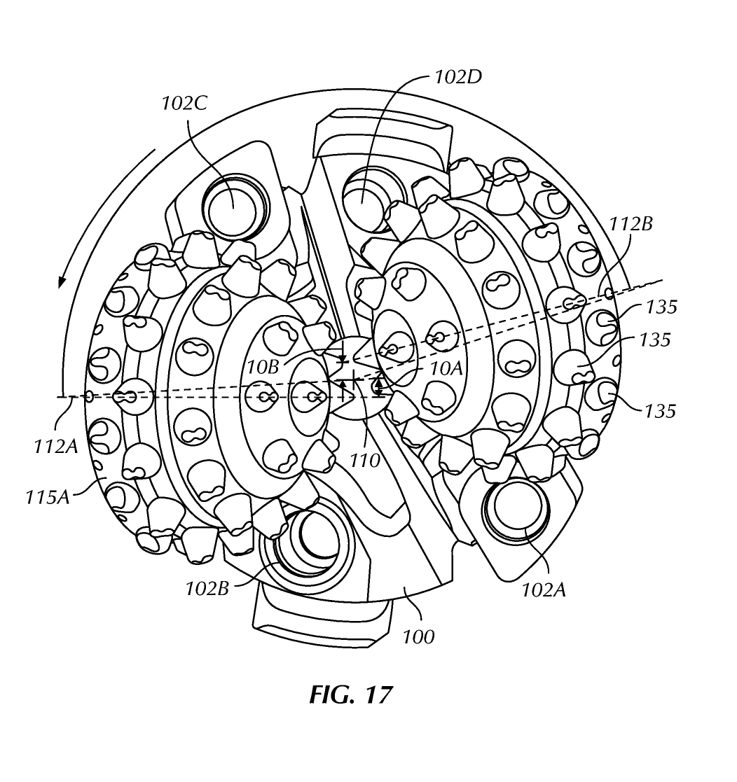

Turning to FIG. 17, the journals may be formed such that an cone separation angle and a cone offset exists between the two journals. As used herein, the term “cone separation angle” may be used to describe an angle θ between the journal axes 112A and 112B. According to an embodiment of this disclosure, the roller cone may be mounted to the journal such that the cone separation angle is determined by the separation angle of the journal. Therefore, as used in reference to FIG. 17, the separation angle of the journals is equivalent to the cone separation angle. The cone separation angle is included to improve the stability of the two cone drill bit. In some embodiments, the cone separation angle between the cones may be less than 177 degrees or 175 degrees, in a range of 172 to 177 degrees in one or more particular embodiments, or less than 172 degrees in yet other embodiments.

In the embodiment shown in FIG. 17, the journal axis 112A, 112B, about which each roller cone 115A, 115B rotates, is also angled slightly away from the center axis 110 of the drill bit. This is known as “cone offset.” Cone offset can be determined by viewing the drill bit from the bottom on a horizontal plane that is perpendicular to the center axis 110. A positive offset is defined by an angle with the direction of rotation of the drill bit. A negative offset is defined by an angle against the direction of rotation of the drill bit. The amount of cone offset 10A, 10B may be measured by the minimum distance between the center axis 110 of the drill bit and the journal axis 112A, 112B when projected on the horizontal plane. In this particular embodiment, a positive cone offset 10A, 10B is shown for the roller cones 101A, 101B. In another embodiment, a combination of positive offset and negative offset (i.e. one roller cone has a positive offset and one roller cone has a negative offset) is used to improve the lateral stability of the two cone drill bits. Yet in another embodiment, a combination of varying the positive offset (i.e. one roller cone has a lower or higher positive offset than the other roller cone) is used to improve the lateral stability of the two cone drill bits. The cone offset 10A, 10B forces the roller cones 115A, 115B to scrape while rolling to remove earth formation. The ratio of scraping to rolling varies based on the amount of cone offset. One skilled in the art of drill bit design would appreciate that an increase in the cone offset 10A, 10B results in an increase in scraping. The amount of cone offset is often expressed in relation to the diameter of the drill bit. For example, an embodiment may have an offset of 1/32 inch per inch of bit diameter. One of ordinary skill in the art will appreciate that the amount of cone offset may vary for embodiments without departing from the scope of this disclosure, in some embodiments, in two cone drill bits, a combination of offsets can bring about lateral stability during drilling.

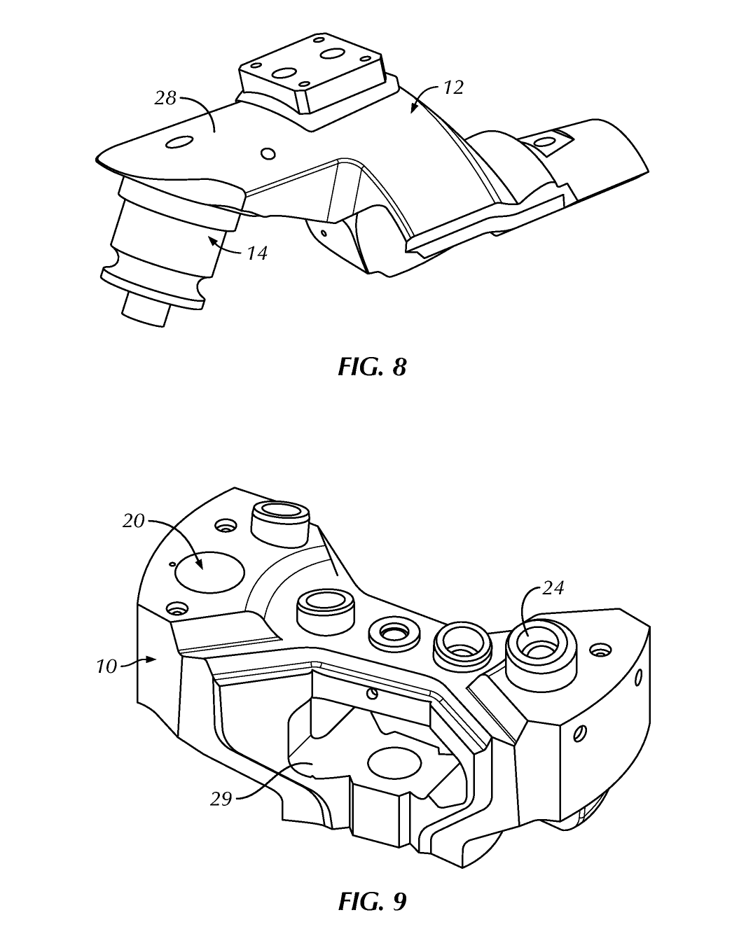

Once the legs 12 have been machined and assembled with roller cones 16, the legs may be welded or otherwise coupled to a wedge section 10. Referring to FIGS. 9 and 10, the wedge section 10 may be a dogbone shape such that a first leg 12 is welded to a first side of wedge section 10 and a second leg 12 is welded to a second side of wedge section 10 to form the drill bit. Once assembled, a central fluid plenum (not shown) may be formed from internal surfaces 29. Wedge section 10 may be machined from a single piece of material and may include at least one protruding shoulder balancer 11 disposed on an upper surface or shoulder 26 (the transition between the gage defining region and the ultimate pin end of the bit) of the wedge section 10. On the opposite side of wedge section 10 from shoulder 26, wedge section 10 may also include a plurality of openings 20 on a lower surface thereof. The plurality of openings 20 in the wedge section 10 may introduce drilling mud that flows from the central fluid plenum (not shown) out the openings 20 into the space around the roller cones 16. During drilling operations, cuttings and debris may accumulate around the roller cones and at the bottom of the bore hole. Fluid may be pumped downhole during operation for cuttings removal, cone cleaning, bottom hole cleaning, and bit cooling. Further, the plurality of openings 20 may be configured to receive a sleeve or nozzle attachment 24.

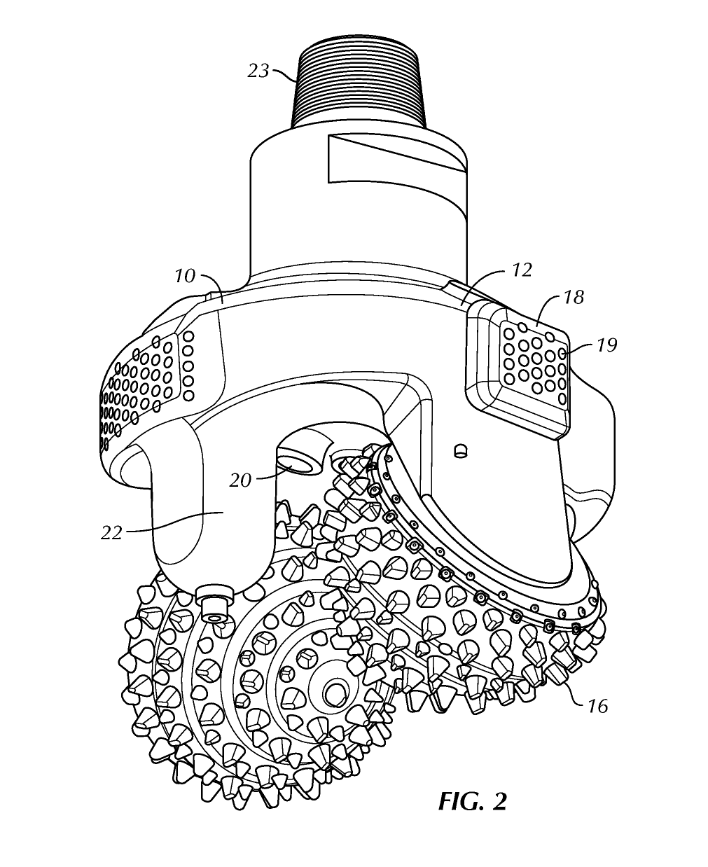

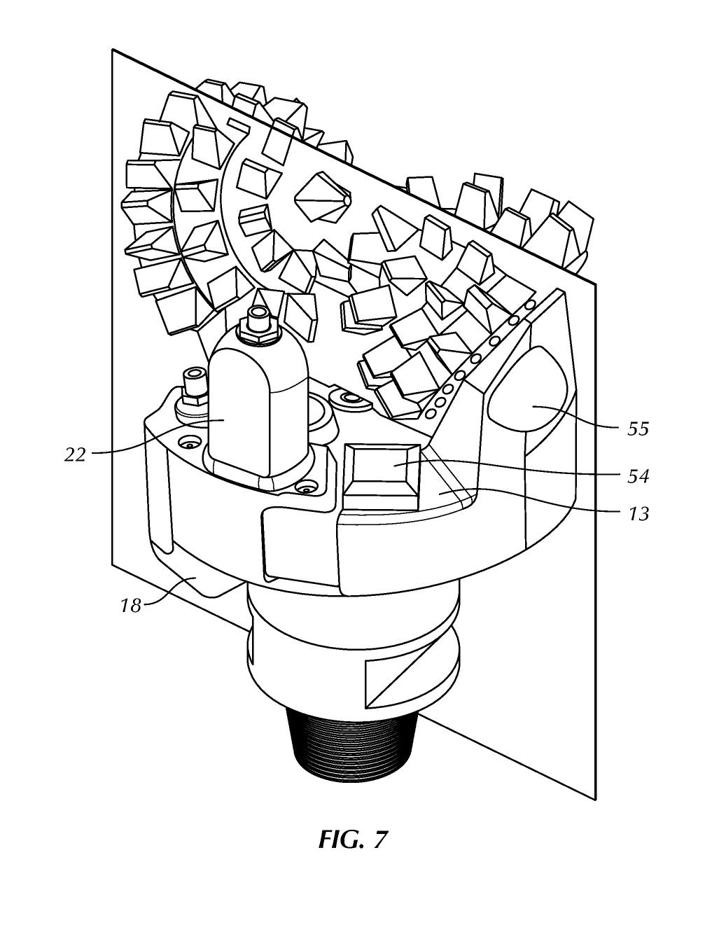

As shown in FIGS. 2 and 7, in some embodiments, a nozzle extension balancer 22 may be included to improve bit hydraulics and increase rate of penetration. According to embodiments of the present disclosure, the nozzle extension balancer 22 may be included to add stability to the two cone drill bit. The nozzle extension balancer may be formed from, for example, steel or a denser metal matrix composite material such as tungsten carbide (WC) or thermally stable polycrystalline diamond (TSP) on at least a portion of the nozzle extension balancer. According to some embodiments at least one nozzle extension balancer 22 may be coupled to one of the openings (shown as 20 in FIG. 9) on the underside of at least one of the wedge sections 10 between legs 12. As seen in FIG. 2, the nozzle extension balancer 22 protrudes axially downward from the bit body 7 at a position that overlaps the cones 16 from both a radial perspective as well as an axial perspective. As discussed above, two cone drill bits are prone to vibrations due to instability. By incorporating the nozzle extension balancer 22 on the drill bit 5, mass is added below the wedge section 10, thereby lowering the center of gravity (COG) of the drill bit 5 and improving stability. In some embodiments a nozzle extension balancer 22 may have more than one flow path. In other embodiments a drill bit 5 may have more than one nozzle extension balancer 22 coupled to the openings 20, and may include at least one nozzle extension balancer 22 extending downward from the side of each wedge section 10 (between each leg 12).

Referring back to FIG. 1, once the legs 12 and wedge 10 have been welded to form the bit body 7, an upper section 17 including a pin end 23 may be welded to an upper end of the drill bit. In other embodiments, the upper section 17 and pin end 23 may be integrally formed from the bit body 7. The pin end 23 provides a connection for attachment to a drill string. The pin end 23 may define a bit axis or pin axis 6, which refers to a longitudinal axis which runs through the center of the pin. In some embodiments, the pin end 23 may be a threaded pin end.

As shown in FIGS. 1 and 2, in some embodiments, stabilizer pads 18 may be machined into the outer diameter of the wedge section 10 and the outer surface of the legs 12. Alternatively, in some embodiments the stabilizer pads may be coupled to the outer diameter of the wedge section 10 and the outer surface of the legs 12 by, for example, welding, riveting, and any other coupling means known in the art. The outer surface of stabilizer pads 18 may also include a plurality of inserts 19 inserted into holes formed in the outer surface of stabilizer pads 18. The stabilizer pads 18 and the plurality of inserts 19 may define the outer diameter of the drill bit to provide additional support to the body 7 and legs 12 of the drill bit to reduce lateral movement of the drill bit within the well, providing stability of the drill bit downhole. Inserts 19 may be formed from WC, TSP or any other super hard material known in the art. Additionally, inserts 19 may be placed on stabilizer pads 18, and wear resistant hard facing may be welded around the inserts 19. The inserts 19 may be installed to be flush with the stabilizer pads and/or extend beyond the outer diameter of the stabilizer pads 18. This provides increased contact area to for increased stability. The stabilizer pads 18 may be ground or milled to a desired outer diameter after the assembly of the components to ensure tight concentricity with the bit axis 6. Further, depending on the amount of weight needed to shift, the shape (and location) of the stabilizer pads 18 may vary.

As mentioned, several of the features present on a drill bit may be used to incorporate additional weight into the drill bit, at different axial and/or radial positions. Incorporation of such features may allow for drill bit balancing to occur. As used herein, the phrase “drill bit balancing” or “balancing operations” may include aligning at least one of a center of gravity of the drill bit or the inertia tensor of the drill bit with the bit axis. In some embodiments, drill bit balancing operations may include aligning both the center of gravity and the inertia tensor with the bit axis.

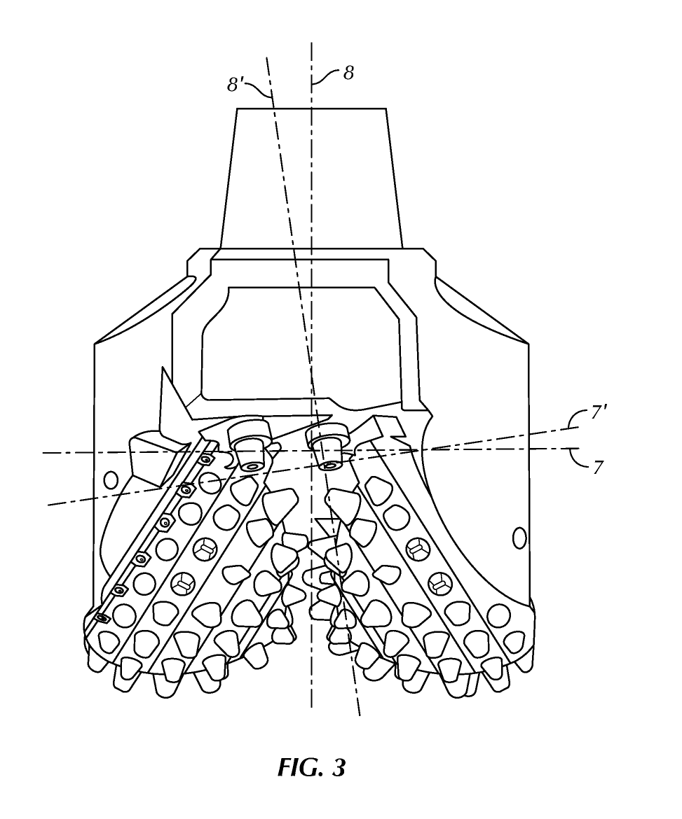

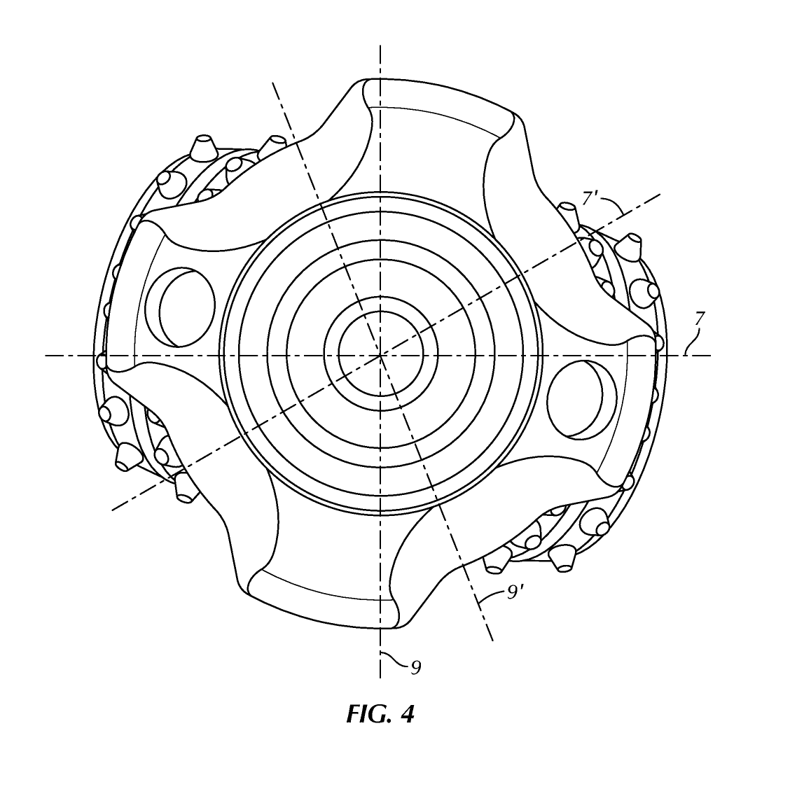

The inertia tensor describes an amount of torque (τ) to impart rotational an acceleration (dω) to an object. Referring to equation (1), provided below, the inertia tensor (I) may be represented by a 3-by-3 matrix. The inertial value I for an object is proportional to the amount of torque required to produce a specific rotational acceleration. The x-axis, y-axis, and z-axis with respect to a drill bit may be seen in FIGS. 3-5.

$$[ \begin{matrix}{τ}_{x} \\ {τ}_{y} \\ {τ}_{z}\end{matrix} ] = [ \begin{matrix}{I}_{xx} & {I}_{xy} & {I}_{xz} \\ {I}_{yx} & {I}_{yy} & {I}_{yz} \\ {I}_{zx} & {I}_{zy} & {I}_{zz}\end{matrix} ] [ \begin{matrix}d {ω}_{x} \\ d {ω}_{y} \\ d {ω}_{z}\end{matrix} ] \qquad ( 1 )$$

For an ideal symmetric and balanced object, torque applied along, for example, the x-axis, will result in rotation about the x-axis, torque applied along the y-axis will result in rotation about the y-axis, etc. That is, the inertia tensor for an ideal symmetric and balanced object has nonzero values for the diagonal entries (i.e. Iₓₓ, I_{yy}, and I_{zz}) of the matrix and zeroes in the non-diagonal entries. However, for an asymmetric object, torque applied along the x-axis may result in rotation along the x-axis as well as the y-axis and z-axis. That is, the inertia tensor may have non-zero values for I throughout the matrix. Given that drill bits are asymmetric objects, the inertial tensor matrix for the drill bit will generally possess non-zero values throughout the matrix. In some embodiments, the drill bit may be balanced, not just by considering the drill bit's center of gravity relative to the pin axis, but also by considering the inertial tensor. Thus, in such a manner, the drill bit may be axially balanced as well as radially balanced.

FIGS. 3-5 provide a frame of reference for the drill bit 5 with respect to a the x-axis 7, y-axis 8, and z-axis 9. The drill bit 5 may be rotated about the y-axis 8 such that torque is applied about the y-axis 8. Ideally, torque applied to the drill bit 5 about the y-axis would result in rotational acceleration about the y-axis and not the x-axis and z-axis. In other words, the I_{xy}/I_{yx} and I_{zy}/I_{yz} values would be zero. However, a drill bit is asymmetric, and thus for a general two cone drill bit, the I_{xy}/I_{yx} and I_{zy}/I_{yz} values are not zero. Non-zero values for I_{xy}/I_{yx} and I_{zy}/I_{yz} result in rotational acceleration in the x-axis and z-axis, which may contribute to undesired vibrations and eccentricities in the drill bit and drill string during operation. The present inventors have found that by reducing the I_{xy}/I_{yx} and I_{zy}/I_{yz} values to about zero (or closer to zero), such that the I_{y} vector is in line with the y-axis, greater drill bit stability may result. As used herein, the “I_{y} vector” refers to the vector comprising the second column or second row of the inertia tensor I. Axes indicated by 7′, 8′, and 9′ refer to the Iₓ, I_{y}, and I_{z} vectors, respectively.

Referring to FIG. 11, according to an embodiment of the present disclosure, the drill bit may be manufactured such that the stabilizer pads axis 4 and the cones axis 3 is aligned with the pin axis 6 (described above as extending through the center of the pin 23). As used herein the term “stabilizer pads axis” is a longitudinal axis that runs through the mid-portion of the bit body 7 (with an upper bounds of the shoulders 25 of the legs to a lower bounds of the underface 13 of the wedge sections 10) such that the stabilizer pads axis 4 is substantially in the center of the stabilizer pads 18 disposed on wedges 10 and legs 12. As used herein, the term “cones axis” or “roller cones axis” is a longitudinal axis that runs through a point located equidistance from the apex of the two cones (with a bounds defined by the axial distance of the cones 15). As mentioned above, embodiments of the present disclosure relate to balancing of a drill bit and alignment of axes. In one or more embodiments, the pin axis 6 may be aligned with the I_{y} vector. In other embodiments, the pin axis 6 may be aligned with a center of gravity of the drill bit. When designed according to the present disclosure, the three axes (stabilizer pads axis 4, cones axis 3, and pin axis 6) are aligned to define the bit axis. But when manufactured, manufacturing tolerances may result in misalignment between the three axes. In other embodiments according to the present disclosure, the three axes, the inertia tensor, and the center of gravity may be aligned. One of ordinary skill in the art would understand that the various axes as well as the inertia tensor and center of gravity may be aligned in various combinations without departing from the scope of the present application.

In order to perform the drill bit balancing operations, a drill bit may be modeled using Computer Aided Design (CAD) software, for example, Pro/Engineer, SolidWorks, AutoCAD, Autodesk, or other CAD software known in the art. Drill bit characteristics including, for example, drill bit mass, center of gravity (COG) coordinates of the drill bit, inertia tensor, and bit volume, may be provided by the model. One of ordinary skill in the art will understand that other physical properties of the drill bit may be provided by the model. These drill bit characteristics may then be input into a simulator to perform drill bit balancing operations.

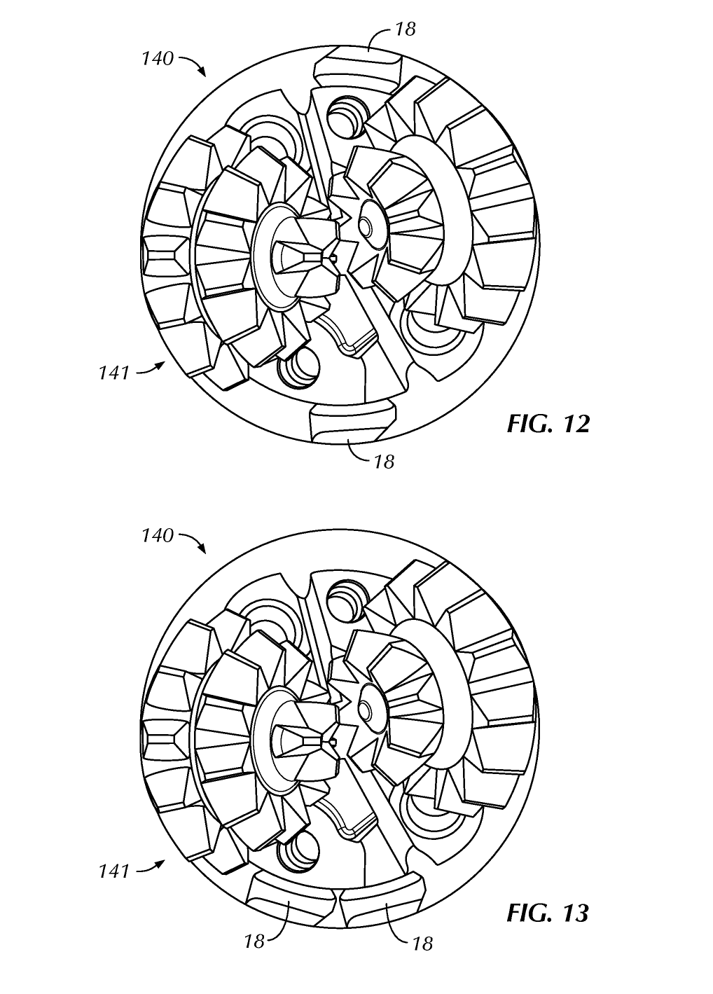

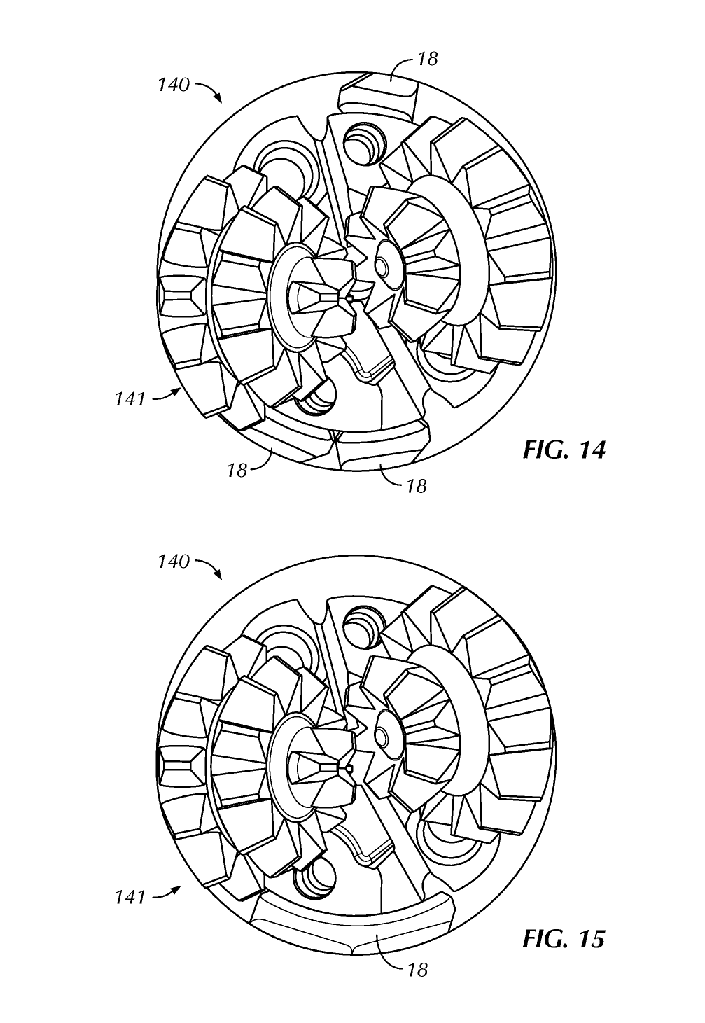

After inputting the drill bit characteristics into a simulator, static balancing operations may be performed. A drill bit is considered statically balanced if the center of gravity of the pin is in line with the pin axis. According to one embodiment of the present disclosure, a drill bit may be statically balanced by changing the number, location and/or size of the stabilizer pads. Referring to FIGS. 12 and 13, a stabilizer pad may be moved from an over-weighted side 140 to under-weighted side 141. Alternatively, an additional stabilizer pad may be added to an under-weighted side 141, as seen in FIG. 14. In this way, the COG of the drill bit may be moved closer to the pin axis 6. Referring to FIG. 15, the COG of the drill bit may be moved closer to the pin axis 6 by increasing the size of a stabilizer pad 18 on the under-weighted side and/or decreasing the size of the stabilizer pad on the over-weighted side. One of ordinary skill in the art will understand that a combination of changing the location of the stabilizer pads 18 and changing the size of a stabilizer pad may be used without departing from the scope of the present disclosure.

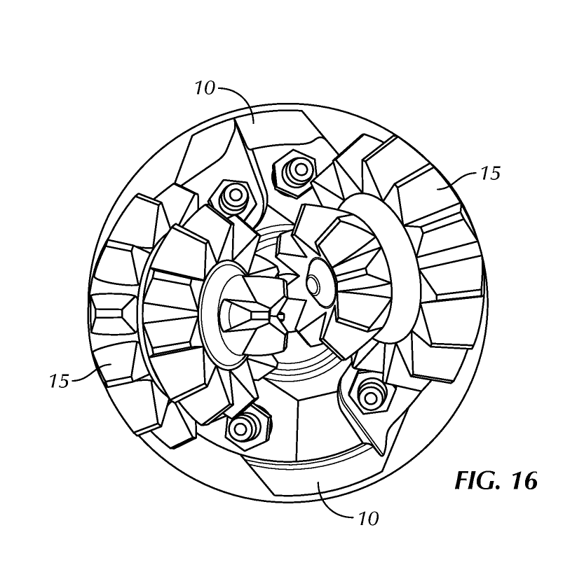

According to another embodiment of the present disclosure, the wedge 10 and/or legs 12 may be designed to be asymmetric about the pin axis 6 to compensate for imbalance introduced by cone separation angles (discussed above with reference to FIG. 17). As shown in FIG. 16, wedge sections 10 on opposite sides of the drill bit may have a different weight and mass distribution. According to some embodiments, each leg 12 may have a different weight and mass distribution or both the wedge sections and legs 12 may have a different weight and mass distribution. Such mass distribution may be achieved through the initial design (to create either a larger or smaller wedge), by machining (to remove material from a wedge), or through the use of weighted bodies that can be inset into the wedges, etc.

According to another embodiment of present disclosure, static balancing operations may include simulating to find a static mass value that can be added to the drill bit in order to align the center of gravity of the drill bit with the pin axis. As used herein, the term “static mass” may refer to a mass that is added to the drill bit (such as in the form of the nozzle extender balancers, stabilizer pads, changes to the wedge geometry, etc) to achieve static balancing. One of ordinary skill in the art will understand, after reading the present disclosure, that more than one static mass may be added to the drill bit (in at least one location) in order to align the center of gravity with the pin axis and that the number (or location) of masses added to the drill bit for static balancing operations should not be seen as limiting the scope of the present disclosure.

In addition to the drill bit characteristics, a radial offset, corresponding to an approximate location of the static mass along the x-axis, and a static longitudinal offset, corresponding to an approximate location of the static mass along the y-axis may be determined and input into the simulator. The radial and axial position may be defined as a function of the available space between the cones. One of ordinary skill in the art will understand that the radial offset may alternatively correspond to an approximate location of the static mass along the z-axis depending on the orientation of the drill bit with respect to the coordinate system. In some embodiments, the radial offset alone may be input into the simulator to perform static balancing. Using the mass of the drill bit, the location of the center of gravity of the drill bit, and radial and longitudinal offsets, the static mass characteristics including mass value, COG coordinates may be determined.

Once the static mass characteristics have been calculated, the new statically balanced drill bit characteristics may be determined. The statically balanced drill bit characteristics may include a new mass, the COG coordinates, and the inertia tensor for the statically balanced drill bit. If the static balancing is performed correctly, the COG coordinates for the statically balanced drill bit should have values of about zero corresponding to the x and z coordinates. As used with respect to the x and z coordinates of the COG for the statically balanced drill bit, the phrase “about zero” may refer to a value of within 0.03 in of 0 for bit diameters 3½ ft thru 12¼ in, within 0.05 in of 0 for bit sizes larger than 12¼ in thru 20 in, and within 0.08 of 0 in for bit sizes 20 in and larger, and in some embodiments, may refer to a value of within about 0.03 in of 0 for bit diameters 3½ ft thru 12¼ in, within about 0.05 in of 0 for bit sizes larger than 12¼ in thru 20 in, and within about 0.08 of 0 in for bit sizes 20 in and larger.

Following static balancing operations (or instead of if just dynamic balancing is to be performed), dynamic balancing operations may be performed. Dynamic balancing operations may include adding at least two masses or dynamic masses to the drill bit in order to align the inertia tensor with the pin axis. The pair of dynamic masses may provide a force couple. As used herein, the term “dynamic mass” may refer to a mass that is added to the drill bit to achieve dynamic balancing. One of ordinary skill in the art will understand that more than two dynamic masses may be added to the drill bit in order to align the inertia tensor with the pin axis, and the number of masses added to the drill bit for dynamic balancing operations should not be seen as limiting the scope of the present disclosure.

In order to perform dynamic balancing, a first dynamic longitudinal offset for a first dynamic mass and a second dynamic longitudinal offset for a second dynamic mass may be input into the simulator. Referring to FIG. 3, the first longitudinal offset may be located below the origin of the axes at a negative value along the y-axis 8, while the second longitudinal offset may be located above the origin of the axes. One of ordinary skill in the art will understand that in other embodiments, the first longitudinal offset may be located above the origin of the axes and the second longitudinal offset may be located below the origin without departing from the scope of this disclosure. The I_{xy} value of the statically balanced drill bit (or original drill bit) and the distance between the first and second longitudinal offset may be used to determine the mass value and coordinates (x,z) of the first and second dynamic mass. In some embodiments, the value of the first and second dynamic mass may be substantially the same. In other embodiments, the value of the first and second dynamic masses may be substantially different. Using the mass value and COG coordinates of the first and second dynamic masses, the inertia tensors corresponding to the first and second dynamic masses may be calculated.

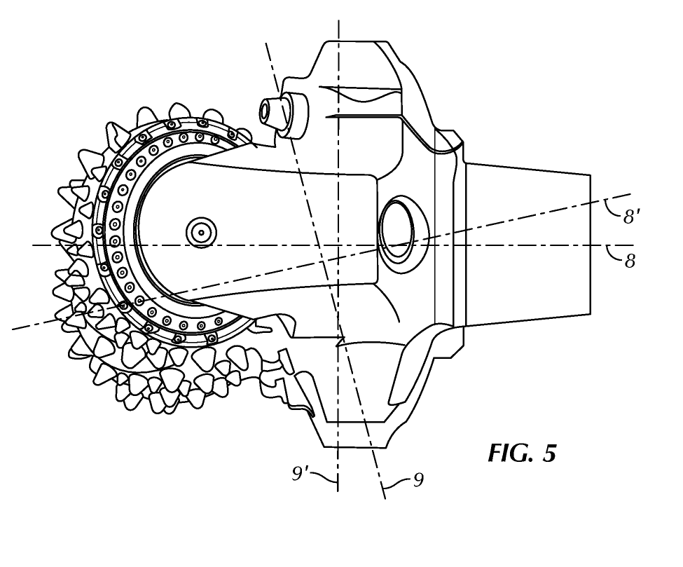

Referring to FIG. 5, next, the dynamically balanced drill bit characteristics may be determined from the mass value, COG coordinates, and inertia tensor of the first and second dynamic masses and the drill bit characteristics (i.e. mass value, COG coordinates, and inertia tensor) of the statically balanced drill bit. If the dynamic balancing is performed correctly, then the I_{xy}, I_{yx} and I_{zy}, I_{yz} values should be about zero. Another way to verify that the dynamic balancing has been performed correctly is to have a unbalancing factor less than 0.01. The unbalancing factor may be defined by the following ratio

√(I_{xy}²+I_{yz}²) [symbol] I_{xy}|

An unbalancing factor of less than 0.01 corresponds to a misalignment of 0.5° between 8 and 8′. For smaller drill bits, e.g. less than 12¼ in, an unbalancing factor of less than 0.02 may be acceptable. In the event that the dynamically I_{xy}, I_{yx} and I_{zy}, I_{yz} values are not about zero, the dynamic balancing operations, or alternately, the dynamic and static balancing operations, may be performed again.

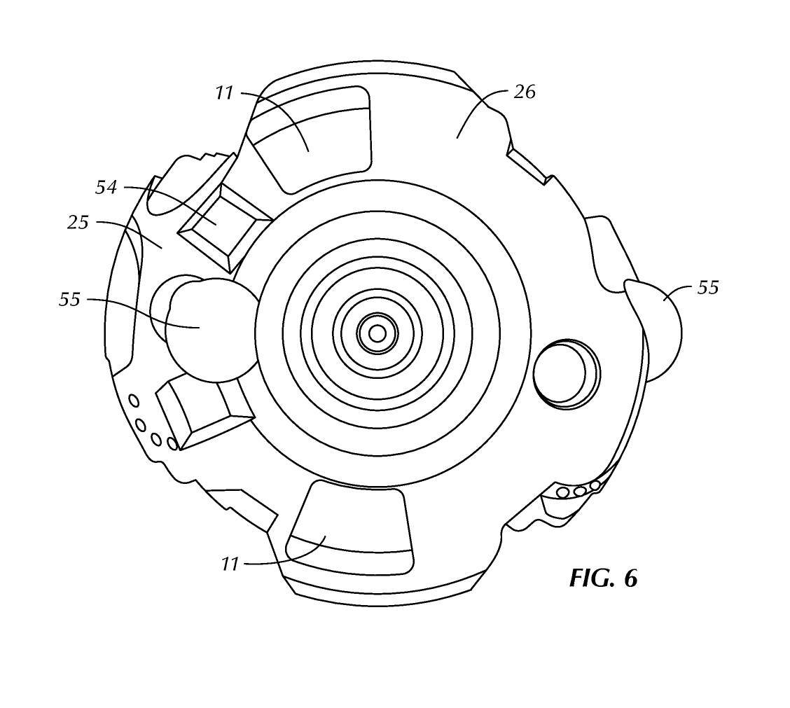

Once the balancing operations are completed and a new mass and COG of the dynamically balanced drill bit are determined, a drill bit with a new mass distribution representative of the static mass and dynamic masses may be determined by modeling the dynamically balanced drill bit using CAD software. As used herein, the term “new mass distribution” refers to a drill bit with the drill bit characteristics of the dynamically balanced drill bit. In some embodiments, the static and dynamic masses may be represented in the model by a sphere of steel. As seen in FIG. 6, the steel spheres provide a visualization of the volume and location of the corresponding static mass (not shown) and dynamic masses 55. If the dynamically balanced drill bit model is feasible, then the drill bit may be materially produced with the new mass distribution. If the dynamically balanced drill bit model is not feasible, then the static and/or dynamic balancing operations should be repeated. A dynamically balanced drill bit model is considered feasible if a physical drill bit may be altered to produce the new mass distribution without interfering with drill bit functionality.

For an as-manufactured finished drill bit, the mass distribution of the drill bit may be modified by adding or removing mass from the drill bit based on the new mass distribution, which factors in manufacturing tolerances and variations in welding volume. Modifying the mass distribution may not produce a drill bit identical to the dynamically balanced drill bit model, as adding multiple spherical volumes to the surface of the drill bit, as seen in FIGS. 6 and 7, may be impractical. Rather, mass may be added to or removed from specific regions of the drill bit in order to produce a drill bit with the same drill bit characteristics as the dynamically balanced drill bit model. Referring to FIG. 10, these regions may include, for example, stabilizer pads 18, shoulders 25 of legs 12 or wedge section 10 (such as in a protruding shoulder balancer 11), the top surface of the bit body, or the nozzle extension balancer 22. As shown in FIGS. 6 and 7, in some embodiments, weighted pads 54 may be added to the shoulder 25 of the legs and/or the shoulder 26 of the bit body in the wedge section, as well as to the underface 13 of the wedge section. One of ordinary skill in the art will understand that mass may be added and removed from other regions of the drill bit without departing from the scope of this disclosure. Adding mass to the drill bit may include welding material or pressing high density material to the drill bit. Removing mass from the drill bit may include machining or drilling material from the drill bit.

For a drill bit that has not yet been manufactured, the drill bit may be materially produced as described above. Specifically, materially producing the drill bit includes machining a bit body 7 of the drill bit 5, where the bit body 7 includes at least two legs 12 and a wedge section 10. The wedge section 10 may be machined to include a number of openings 20. Sleeves or nozzle attachments 24 may then be welded or otherwise coupled to the body. The legs 12 of the drill bit may then be machined. One of ordinary skill in the art will understand that the order of machining the bit body and the legs are not intended to limit the scope of the present application. The legs 12 may be machined to include journals disposed thereon. In some embodiments, the journals may be integrally formed with the legs 12. In other embodiments, the journals may be machined separately from the legs 12 and subsequently coupled to the legs 12 using, for example, welds, a braze, rivets, a press fit or any other coupling means known in the art. A roller cone with cutting structures disposed thereon may be mounted on each journal, and retained, for example, by a ball bearing retention system.

After machining the leg sections and mounting the roller cones on the journals, the drill bit may be assembled. Specifically, bit body and legs may be welded together. Once the bit body and the legs have been welded, an upper section 17 of the drill bit may be machined. In some embodiments, the upper section 17 may be a separate component welded to the top of the welded bit body and legs. In other embodiments the upper section may be formed integrally from the welded bit body and legs. The upper section includes a pin end 23. A nozzle balancer 22 may also be welded or otherwise coupled to the bit body. For example, the nozzle balancer may be welded, brazed, or press fit to the bit body. Further, stabilizer pads 18 disposed on the legs and bit body may be machined. The stabilizer pads may define an outer diameter of the drill bit. The stabilizer pads may also include a plurality of inserts installed thereon. The inserts may be welded or press fit to the stabilizer pads. Once the drill bit has been manufactured, the mass distribution of the drill bit may be modified by adding or removing mass from the drill bit.

### Example

To demonstrate the effectiveness of the drill bit balancing operations, a drill bit was modeled using Pro/Engineer. Although, one of ordinary skill in the art will understand that other CAD software may be used without departing from the scope of this disclosure. The drill bit characteristics of the modeled drill bit are provided below in Table 1 below. The unbalanced drill bit characteristics (provided in the first section of Table 1 below), including unbalanced inertia tensor matrix, mass, and COG coordinates of the drill bit, were then provided to the simulator as inputs. The angle Z₀-X₀ and the length of the hypotenuse between those Z₀ and X₀ were then calculated using expression (2) and Pythagorean's theorem, respectively.

180°+a tan(Z₀,X₀) (2)

In addition, referring to FIGS. 3-5, a radial offset of 9 in. on the x-axis of the drill bit and a longitudinal offset of −1.77 in. along the y-axis were input into the simulator. The radial offset value may be determined by selecting the maximum radial value for reducing the mass. The longitudinal offset may be any value to reduce the dynamic unbalance.

TABLE 1
Unbalanced bit characteristics

| Unbalanced inertia tensor (lbs*in²) | | | M₀ | 1353.565 | lbs |
|---|---|---|---|---|---|
| 109356.1 | −101.46 | 2828.74 | X₀ | −0.0494 | in |
| −101.46 | 79815.5 | 55.18 | Y₀ | 0.2604 | in |
| 2828.74 | 55.18 | 126684.7 | Z₀ | 0.0063 | In |

Once the inputs were entered into the simulator, the static mass value (shown in Table 2 below) was determined by multiplying the mass of the drill bit (M₀) by the Z₀-X₀ hypotenuse and dividing the product by the radial offset. Next the COG coordinates for the static mass were calculated. Xₛₜ was determined by multiplying the radial offset by sine of angle Z₀-X₀, Yₛₜ was determined by adding the longitudinal offset to Y₀, and Zₛₜ was determined by multiplying the radial offset by sine of angle Z₀-X₀. The inertia tensor for the static mass was then calculated using equations (3) shown below.

Iₓₓ=Mₛₜ(Yₛₜ²+Zₛₜ²)

I_{yy}=Mₛₜ(Xₛₜ²+Zₛₜ²)

I_{zz}=Mₛₜ(Xₛₜ²+Yₛₜ²)

I_{xy}=I_{yx}=Mₛₜ(Xₛₜ×Yₛₜ)

I_{xz}=I_{xy}=Mₛₜ(Xₛₜ×Zₛₜ)

I_{yz}=I_{zy}=Mₛₜ(Yₛₜ×Zₛₜ) (3)

In order to determine the value of the statically balanced drill bit characteristics shown in Table 2, the sum of the corresponding values of mass, COG coordinates, and inertia tensor, were taken. That is, the sum of M₀ and Mₛₜ was taken to give M_{bal-static}. X_{bal-static}, Y_{bal-static} and Z_{bal-static} are given by the equations (4).

X_{bal-static}=(Mₛₜ·Xₛₜ+M₀·X₀)/(M₀+Mₛₜ)

Y_{bal-static}=(Mₛₜ·Yₛₜ+M₀·Y₀)/(M₀+Mₛₜ)

Z_{bal-static}=(Mₛₜ·Zₛₜ+M₀·Z₀)/(M₀+Mₛₜ) (4)

As seen in Table 2, the X_{bal-static} and the Y_{bal-static} are about zero, as desired. Thus, if the angle Z₀-X₀ and the length of the hypotenuse between those Z₀ and X₀ were to be calculated, they would also be about zero. Similar to the mass and COG calculation for the statically balanced drill bit, the inertia tensor matrix for the statically balanced drill bit was produced by the sums of each like element of the static mass inertia tensor matrix and unbalanced inertia tensor matrix.

TABLE 2
Static mass characteristics

| Static mass inertia tensor (lbs*in²) | | | Mₛₜ | 7.4949 | lbs |
|---|---|---|---|---|---|
| 27.1 | 101.46 | 76.65 | Xₛₜ | 8.9268 | in |
| 101.46 | 607.1 | −13.02 | Yₛₜ | −1.5165 | in |
| 76.65 | −13.02 | 614.5 | Zₛₜ | −1.1457 | in |

Statically balanced drill bit characteristics

| Statically balanced inertia tensor (lbs*in²) | | | M_{bal-static} | 1361.0599 | lbs |
|---|---|---|---|---|---|
| 109383.17 | −3.108E−05 | 2905.393 | X_{bal-static} | 9.0510E−09 | in |
| −3.108E−05 | 80422.62 | 42.162 | Y_{bal-static} | 0.2507 | in |
| 2905.393 | 42.162 | 127299.16 | Z_{bal-static} | 1.9577E−17 | In |

Next, dynamic balancing operations were performed, the data for which is shown in Table 3 below, to find the phase angle, mass values, and position that will result in about zero values for I_{xy} and I_{yz} in the inertia tensor matrix. In the example simulation, a first longitudinal offset of −6 in. for a first dynamic mass and a second longitudinal offset of 4 in. for a second dynamic mass were input into the simulator. An angle I_{xy}-I_{yz} for the statically balanced drill bit was determined using expression (2), substituting the statically balanced I_{xy} and I_{yz} for z₀ and x₀, respectively. Next the COG of the first and second dynamic masses were calculated. In order to determine the X_{dyn1}, the longitudinal distance between the first and second dynamic masses was multiplied by the sine of the angle for the statically balanced drill bit. Z_{dyn1} was determined by multiplying the longitudinal distance between the first and second dynamic masses by the cosine of angle I_{xy}-I_{yz} for the statically balanced drill bit. In this example, X_{dyn2} and Z_{dyn2} were determined by taking the negative of X_{dyn1} and Z_{dyn1}.

The first dynamic mass was then calculated by dividing the I_{xy} value for the statically balanced drill bit by the product of M_{bal-static} and the longitudinal distance between the first and second dynamic masses. In this example, the value of the first and second dynamic masses are equal. The inertia tensor of the first and second dynamic masses were then found using equations (4) as applied to the M_{dyn1} and COG coordinates (X_{dyn1}, Y_{dyn1}, Z_{dyn1}) and M_{dyn2} and COG coordinates (X_{dyn2}, Y_{dyn2}, Z_{dyn2}), respectively.

In order to determine the value of the dynamically balanced drill bit characteristics of mass, COG coordinates, and inertia tensor, the sum of the corresponding values were taken. That is, the sum of M_{dyn1}, M_{dyn2}, and M_{bal-static} was taken to give M_{bal-dyn}, X_{bal-dyn}, Y_{bal-dyn}, and Z_{bal-dyn} were determined by using equations (5). As seen in Table 1, the I_{xy}/I_{yx} and I_{zy}/I_{yz} values are about zero, as desired.

X_{bal-dyn}=(M_{bal-st}·X_{bal-st}+M_{dyn1}·X_{dyn1}+M_{dyn2}·X_{dyn2})/(M₀+M_{dyn1}+M_{dyn2})

Y_{bal-dyn}=(M_{bal-st}·Y_{bal-st}+M_{dyn1}·Y_{dyn1}+M_{dyn2}˜Y_{dyn2})/(M₀+M_{dyn1}+M_{dyn2})

Z_{bal-dyn}=(M_{bal-st}·Z_{bal-st}+M_{dyn1}·Z_{dyn1}+M_{dyn2}˜Z_{dyn2})/(M₀+M_{dyn1}+M_{dyn2}) (5)

TABLE 3
First dynamic mass characteristics

| First dynamic mass inertia tensor (lbs*in²) | | | M_{dyn1} | 0.4216205 | lbs |
|---|---|---|---|---|---|
| 57.3 | 1.86E−05 | 3.11E−05 | X_{dyn1} | 7.3706E−06 | in |
| 1.86E−05 | 42.2 | −25.30 | Y_{dyn1} | −6 | in |
| 3.11E−05 | −25.30 | 15.2 | Z_{dyn1} | −10.0000 | in |

Second dynamic mass characteristics

| Second dynamic mass inertia tensor (lbs*in²) | | | M_{dyn2} | 0.4216205 | lbs |
|---|---|---|---|---|---|
| 48.9 | 1.24E−05 | 3.11E−05 | X_{dyn2} | −7.3706E−06 | in |
| 1.24E−05 | 42.2 | −16.86 | Y_{dyn2} | 4 | in |
| 3.11E−05 | −16.86 | 6.7 | Z_{dyn2} | 10.0000 | In |

Dynamically balanced drill bit characteristics

| Dynamically balanced inertia tensor (lbs*in²) | | | M_{bal-dyna} | 1361.9032 | lbs |
|---|---|---|---|---|---|
| 109489.41 | 0.000 | 2905.393 | X_{bal-dyna} | 0.0000 | in |
| 0.000 | 80506.94 | 0.000 | Y_{bal-dyna} | 0.2499 | in |
| 2905.393 | 0.000 | 127321.08 | Z_{bal-dyna} | 0.0000 | In |

In one embodiment, a method of balancing a drill bit includes inputting drill bit characteristics into a simulator. The drill bit characteristics may include an intertia tensor, a drill bit mass and coordinate of the drill bit center of gravity. Once the inputs have been provided to the simulator, the coordinates of the center of gravity and the I_{y} vector of the inertia tensor may be aligned with the pin axis of the drill bit. After aligning the COG coordinates, I_{y} vector, and pin axis, a new mass distribution of the drill bit may be determined. Determining the new mass distribution of the drill bit may include producing a model of the drill bit. Once the new mass distribution has been determined, a drill bit with the new mass distribution may be materially produced.

In another embodiment, a method of balancing a drill bit may include assembling a drill bit. Characteristics corresponding to the assembled drill bit may then be determined and input into a simulator. Once the inputs have been entered into the simulator, a mass balance may be performed with the simulator. Based on the mass balance a new mass distribution may be determined. Then, the drill bit may be modified by adding or removing mass based on the new mass distribution.

Although the examples of the methods provided herein are directed to the design and manufacture of two cone drill bits, one of ordinary skill in the art would understand that the methods may also be applied to the design and manufacture of three cone drill bits, fixed cutter bits, bi-center bits, hammer bits, hybrid roller cone/fixed cutter bits, or any tool known in the art, including those where asymmetry may cause instability.

Although only a few example embodiments have been described in detail above, those skilled in the art will readily appreciate that many modifications are possible in the example embodiments without materially departing from this invention. Accordingly, such modifications are intended to be included within the scope of this disclosure as defined in the following claims. Moreover, embodiments disclosed herein may be practiced in the absence of any element which is not specifically disclosed.

In the claims, means-plus-function clauses are intended to cover the structures described herein as performing the recited function and not just structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method comprising:
inputting drill bit characteristics into a simulator, wherein drill bit characteristics comprise a drill bit mass, coordinates of the drill bit center of gravity, and an inertia tensor of the drill bit;
aligning the drill bit center of gravity and a vector of the inertia tensor with a bit axis in the simulator, the bit axis running longitudinally through the center of the drill bit;
determining new drill bit characteristics based on the aligning the drill bit center of gravity and the inertia tensor with the bit axis; and
producing a drill bit with the new bit characteristics.

2. The method of claim 1, wherein producing comprises:
machining the drill bit comprising a bit body, two legs, and two cones;
assembling the drill bit; and
modifying a mass distribution of the drill bit by adding mass to or removing mass from the drill bit.

3. The method of claim 2, wherein adding mass to the drill bit comprises at least one selected from the group consisting of welding high density material to the drill bit and pressing high density material to the drill bit.

4. The method of claim 2, wherein removing mass from the drill bit comprises drilling or machining the drill bit.

5. The method of claim 2, wherein mass is added to or removed from at least one selected from the group consisting of a nozzle extension balancer, an upper surface of the bit body, an upper surface of a leg, an outer surface of a leg, and a stabilizer pad.

6. A method comprising:
assembling a drill bit;
inputting drill bit characteristics into a simulator;
performing a mass balance with the simulator;
determining new drill bit characteristics comprising a new mass distribution; and
modifying the drill bit by adding or removing mass according to the new mass distribution.

7. The method of claim 6, wherein performing the mass balance comprises performing at least one of a static mass balance or a dynamic mass balance.

8. The method of claim 7, wherein performing the static mass balance comprises aligning a center of gravity of the drill bit and a pin axis of the drill bit to determine at least one statically balanced drill bit characteristic.

9. The method of claim 8, wherein the at least one statically balanced drill bit characteristic comprises at least one selected from the group consisting of a statically balanced drill bit mass, coordinates of a center of gravity of a statically balanced drill bit, and an inertia tensor of a statically balanced drill bit.

10. The method of claim 7, wherein performing the dynamic mass balance comprises aligning a vector of an inertia tensor of the drill bit and a pin axis of the drill bit to determine at least one dynamically balanced drill bit characteristic.

11. The method of claim 10, wherein the at least one dynamically balanced drill bit characteristic comprises at least one selected from the group consisting of a dynamically balanced drill bit mass, coordinates of a center of gravity of a dynamically balanced drill bit, and an inertia tensor of a dynamically balanced drill bit.

12. The method of claim 6, further comprising inputting a modified set of drill bit characteristics into the simulator; performing a mass balance with a simulator; and determining the new mass distribution.

13. A drill bit comprising:
a body;
two legs mounted to the body;
two journals, one of the two journals mounted to each of the two legs, the two journals having a cone separation angle of less than 180 degrees; and
two roller cones, one of the two roller cones mounted to each of the two journals,
wherein the bit has a center of gravity substantially aligned with a bit axis.

14. The drill bit of claim 13, the body defining at least one opening and the drill bit further comprising at least one nozzle extension balancer coupled to the at least one opening.

15. The drill bit of claim 13, further comprising at least one stabilizer pad mounted on each of the two legs, defining a stabilizer pad axis running longitudinally through the center of the at least one stabilizer pad mounted on each of the two legs.

16. The drill bit of claim 15, wherein the bit axis, a stabilizer pads axis, and a cone axis are aligned, wherein the cone axis is a longitudinal axis that runs through a point located equidistance from apexes of the two cones.

17. The drill bit of claim 13, wherein the bit has an inertia tensor, and the inertia tensor is substantially aligned with the bit axis.

18. The drill bit of claim 13, wherein a center of gravity of the drill bit and an inertia tensor of the drill bit are substantially aligned with a bit axis running longitudinally through the center of the drill bit.

19. A method comprising:
producing a two cone roller cone drill bit having a cone separation angle of less than 180 degrees,
wherein the producing comprises aligning a center of gravity of the two cone roller cone drill bit with a bit axis.

20. The method of claim 19, wherein the aligning comprises at least one selected from the group consisting of adding mass to an under-weighted side of the drill bit and removing mass from an over-weighted side of the drill bit.

21. The method of claim 20, wherein the drill bit comprises a first stabilizer pad on the under-weighted side and a second stabilizer pad on the over-weighted side, and aligning further comprises adding a third stabilizer pad to the under-weighted side, increasing the size of the first stabilizer pad, or decreasing the size of the second stabilizer pad.
